(19) United States
(12) Patent Application Publication
(10) Pub. No.: US 2005/0141504 A1
(43) Pub. Date: Jun. 30, 2005

(54) Methods, systems, and computer program products for encapsulating packet traffic associated with multiple layer two technologies

(76) Inventors: James William Rembert, Atlanta, GA (US); Steven Allen Wright, Roswell, GA (US); Michael Duckett, Alpharetta, GA (US)

Correspondence Address: MYERS BIGEL SIBLEY & SAJOVEC, P.A., P.O. BOX 37428, RALEIGH, NC, 27627, US

(21) Appl. No.: 10/747,735

(22) Filed: Dec. 29, 2003

(51) Int. Cl. H04L 12/28

(52) U.S. Cl. 370/392; 370/238

(57) ABSTRACT

A multiprotocol label switching (MPLS) network is operated by establishing a label switched path (LSP) that connects a first provider edge (PE) label switched router (LSR) a second PE LSR, and a customer edge (CE) LSR. The packet traffic that is associated with a plurality of different layer two technologies is encapsulated with an MPLS label. The encapsulated traffic is securely routed from the first PE LSR through the second PE LSR to the CE LSR using the LSP.

### FIELD OF THE INVENTION

The present invention relates to communication networks, and, more particularly, to multiprotocol label switching (MPLS) communication networks.

### BACKGROUND OF THE INVENTION

Multiprotocol label switching (MPLS) provides a technique for routing packet data based on a label field rather than a destination address. An MPLS network comprises a set of nodes, which are called label switched routers (LSRs), that switch/route packets based on a label that has been added to each packet. Labels are used to define a flow of packets between two nodes or, if packets are being broadcast in a multicast operation, between a source node and multiple destination nodes. A specific path through the LSRs, which is called a label switched path (LSP), is defined for each distinct flow, which is called a forwarding equivalence class (FEC). At intervening nodes in an LSP, an LSR may route the packet based on the MPLS label value, remove the MPLS label (pop a label), and/or impose an additional label (push a label). The label may be removed at the node from the packet at a node that is just prior to the destination node in a particular LSP. This process is sometimes referred to as “penultimate hop popping.”

Referring now to FIG. 1, an exemplary MPLS label and Internet Protocol (IP) packet are illustrated. The MPLS label is a 32-bit header that includes a 20-bit label field, a 3-bit Exp field that is reserved for experimental use, a 1-bit S field that is set to one for the oldest entry in the stack and zero for all other entries, and an 8-bit time-to-live (TTL) field that may be used to encode a hop count or time-to-live value. An MPLS label may also be referred to as an MPLS shim header. As shown in FIG. 1, multiple MPLS labels or shim headers may be included in a single IP packet. The MPLS labels or shim headers are organized as a last-in, first-out stack and are processed based on the top MPLS label or shim header. As discussed above, an LSR may add an MPLS label or shim header to the stack (push operation) or remove an MPLS label or shim header from the stack (pop operation).

Customers of telecommunications services may request higher bandwidth service at key sites, such as data centers and/or headquarters locations, but may not wish to make changes at their numerous branch or spoke sites. More specifically, customers may desire layer two data services that aggregate or interwork their diverse access technologies (e.g., Ethernet, frame relay, ATM, DSL, private lines, etc.) where the aggregation is at layer two or frame layer for efficiency and the wide area network (WAN)/metro area network (MAN) connectivity is across the WAN, not just within a metro region or local access and transport area (LATA). Existing RFC 2547bis and other IP-Virtual Private Network (VPN) technologies may provide layer three VPN services, but, unfortunately, these technologies do not address layer two VPN services. Currently layer two VPN proposals do not provide for multiple layer one and layer two technology aggregation capability on the same interface using MPLS and the option of static LSP provisioning and signaling over a RFC2547bis VPN.

### SUMMARY OF THE INVENTION

According to some embodiments of the present invention, a multiprotocol label switching (MPLS) network is operated by establishing a label switched path (LSP) that connects a first provider edge (PE) label switched router (LSR) a second PE LSR, and a customer edge (CE) LSR. The packet traffic that is associated with a plurality of different layer two technologies is encapsulated with an MPLS label. The encapsulated traffic is securely routed from the first PE LSR through the second PE LSR to the CE LSR using the LSP.

In other embodiments of the present invention, the layer two technologies comprise asynchronous transfer mode (ATM) technology, frame relay technology, point-to-point protocol/high level data link control (HDLC) technology, private line time division multiplexing (TDM), and/or Ethernet technology.

In still other embodiments of the present invention, the MPLS label is signaled between the first PE LSR and the CE LSR and the second PE LSR uses an internal service provider IP-virtual private network to maintain a securely partitioned network for customers.

In further embodiments of the present invention, the MPLS label is statically provisioned from the second PE LSR to the CE LSR and stitched to a signaled LSP in a service provider network that connects the first and second PE LSRs.

In still further embodiments of the present invention, a pseudo wire virtual circuit is provisioned within the LSP for each one of a plurality of attachment circuits at the first PE LSR.

In still further embodiments of the present invention, the LSP and/or pseudo wires, which are terminated via signaling at the second PE LSR, transit on to the CE LSR.

In still further embodiments of the present invention, each of the packets comprising the packet traffic comprises a control word that identifies one of the plurality of different layer two technologies that the respective packet is associated with.

Other systems, methods, and/or computer program products according to embodiments of the invention will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE DRAWINGS

Other features of the present invention will be more readily understood from the following detailed description of specific embodiments thereof when read in conjunction with the accompanying drawings, in which:

FIG. 1 is a block diagram that illustrates a conventional multiprotocol label switching (MPLS) label or shim header and internet protocol (IP) packet;

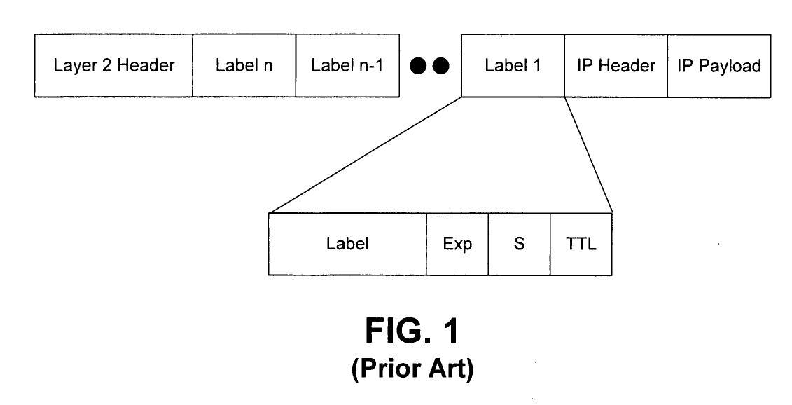

FIG. 2 is a block diagram that illustrates an MPLS network in accordance with some embodiments of the present invention; and

FIG. 3 is a flowchart that illustrates operations for encapsulating and aggregating at an MPLS enabled customer site with an MPLS interface packet traffic that is associated with multiple layer two technologies in accordance with some embodiments of the present invention.

### DETAILED DESCRIPTION OF EMBODIMENTS

While the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention as defined by the claims. Like reference numbers signify like elements throughout the description of the figures.

The present invention may be embodied as systems, methods, and/or computer program products. Accordingly, the present invention may be embodied in hardware and/or in software (including firmware, resident software, micro-code, etc.). Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

As used herein, the term “protocol” refers to a defined set of rules that govern the exchange of data or information between two or more entities. In addition, a “protocol layer” refers to the hierarchical protocol structure represented by the open systems interconnection (OSI) model developed by the International Organization for Standardization in which layer one corresponds to the physical layer, layer two corresponds to the data link layer, layer three corresponds to the network layer, layer four corresponds to the transport layer, layer five corresponds to the session layer, layer six corresponds to the presentation layer, and layer seven corresponds to the application layer.

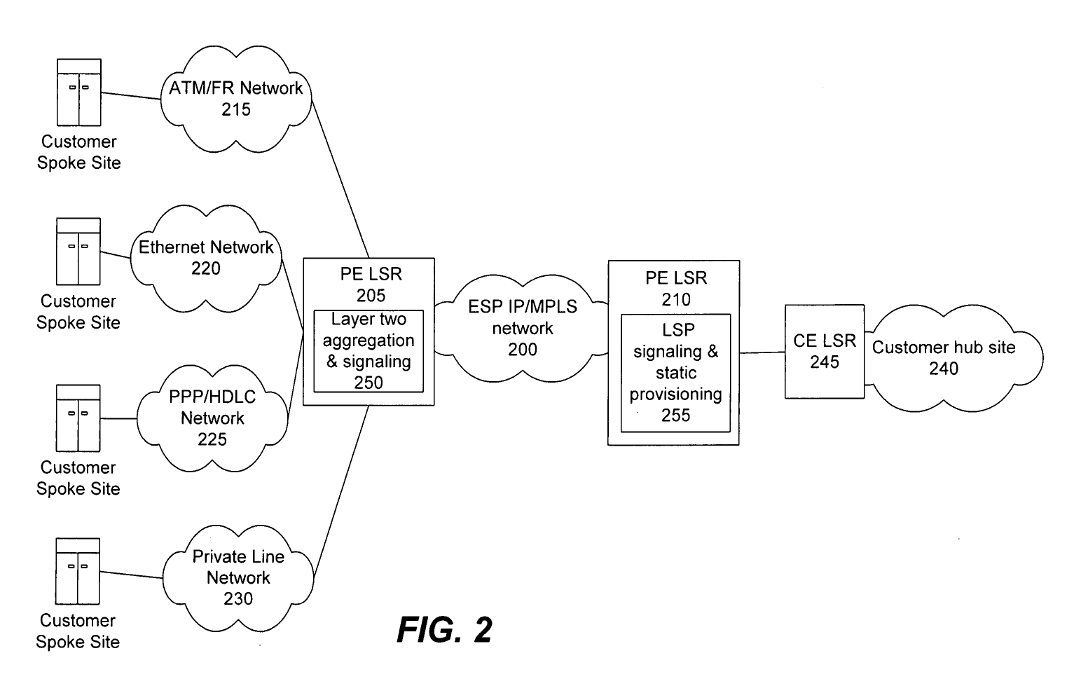

Referring now to FIG. 2, a multiprotocol label switching (MPLS) network, in accordance with some embodiments of the present invention, comprises a service provider (SP) Internet Protocol (IP)/MPLS network 200 that comprises a first provider edge (PE) label switched router (LSR) 205 and a second provider edge (PE) LSR 210. Because the first and second PE LSRs 205, 210 are on the edge of the SP's MPLS network, they may be called “label edged routers” (LERs). The first PE LSR 205 terminates traffic from multiple spoke sites associated with a customer. In particular, traffic from an asynchronous transfer mode (ATM)/frame relay (FR) network 215, an Ethernet network supporting virtual local area networks (VLANs) 220, a point-to-point protocol (PPP)/high level data link control (HDLC) network 225, and a private line TDM network 230 terminate on the PE LSR 205.

The first PE LSR 205 comprises a layer two aggregation and LSP signaling module 250. The second PE LSR 210 comprises an LSP signaling and static provisioning module 255. In accordance with some embodiments of the present invention, the layer two aggregation and LSP signaling module 250 may be configured to aggregate packet traffic that is associated with multiple types of layer two technologies by encapsulating that traffic with one or more MPLS labels. As shown in FIG. 2, a PE LSR configured with a layer two aggregation and LSP signaling module 250 may aggregate traffic associated with layer two technologies such as, but not limited to, private line TDM, ATM, frame relay, PPP, HDLC, and/or Ethernet. Digital subscriber line (DSL) technology is supported via a particular layer two transport technology listed above. Private lines may be any time division multiplexing technology that provides synchronous transport (e.g., DS1, E1, SONET). A PE LSR configured with a LSP signaling and static provisioning module 255 may terminate the service provider edge and its signaling, but allow for continuation of LSPs to the customer edge (CE) LSR 245 or allow signaling to continue to the CE LSR 245. The former corresponds to a situation in which the traffic transits PE LSR 210, but the SP signaling associated with the LSP and pseudo wires is terminated. The continuation LSPs between the PE LSR 210 and the CE LSR 245 is provided by static provisioning or configuration of LSP labels and their stitching to the signaled LSP labels based on mutual agreement between a customer and the service provider. The latter corresponds to a situation where the signaling for LSP labels is from the first PE LSP 205 through PE LSP 210 and onto CE LSR 245. The underlying IP transport in the SP network may be provided by a IP-VPN established inside the SP network from the PE LSR 205 to the PE LSR 210. The interface between the CE LSR 245 and the PE LSR 210 may be called an MPLS user to network interface (MPLS UNI).

The second LSR 210 may establish label switched paths (LSPs) with a hub site 240 associated with a customer. In accordance with some embodiments of the present invention, the pseudo wire virtual circuits may be provisioned within the LSPs at CE LSR 245 for each attachment circuit that is associated with the layer one and two technologies that the customer is using at the spoke locations. For example, the customer may establish a permanent virtual circuit through the ATM/FR network 215 to the PE LSR 205, which may be represented as a pseudo wire virtual circuit at the CE LSR 245. Moreover, the customer may establish a virtual local area network (VLAN) connection through the Ethernet network 220 to the PE LER 205, which may be represented as a pseudo wire virtual circuit at the CE LSR 245. In accordance with further embodiments of the present invention, the LSP between the PE LSR 205 and CE LSR 245 may be signaled up to the second PE LSR 210 from which point it may be statically provisioned or signaled to the CE LSR 245. This is because the first PE LSR 205 terminates traffic from a customer spoke site, which means traffic from multiple customers terminates at the first PE LSR 205. Only the customer that is associated with the hub site 240 is aware of the static label associated with the LSP that connects to the hub site 240 and so that customer is now aware of any other customer or SP LSP labels. Provisioning may effectively stitch the LSP in the SP network statically to a LSP between the PE LSR and the CE LSR. The PE may be required to disintermediate (i.e., interwork) between the SP and the MPLS UNI labels. If the LSP is signaled, then the SP network may support an internal IP-VPN partition for each customer upon which the LSPs will be encapsulated. This is to prevent other customers from accessing the hub site 240 or spoke sites, which are associated with a particular customer, or from potentially interfering with the operation of the SP network. Thus, according to some embodiments of the present invention, signaling options may be provided as part of service provider IP-VPNs (e.g., RFC-2547bis) that are not exposed to the customer for security partitioning.

The service provider network 200 is associated with encapsulation of traffic for multiple layer one and two technologies, which may be considered an enhanced service because it uses computer-based processing applications to provide the customer with value-added telecommunications services, such as protocol conversion.

Although FIG. 2 illustrates an exemplary MPLS network, it will be understood that the present invention is not limited to such configurations, but is intended to encompass any configuration capable of carrying out the operations described herein. It will be appreciated that, in accordance with some embodiments of the present invention, the functionality of the layer two aggregation and LSP signaling module 250 and the LSP signaling and static provisioning module 255 may be implemented using discrete hardware components, one or more application specific integrated circuits (ASICs), a programmed digital signal processor or microcontroller, a program stored in a memory and executed by a processor, and/or combinations thereof. In this regard, computer program code for carrying out operations of the layer two aggregation and LSP signaling module 250 and the LSP signaling and static provisioning module 255 may be written in a high-level programming language, such as C or C++, for development convenience. In addition, computer program code for carrying out operations of the present invention may also be written in other programming languages, such as, but not limited to, interpreted languages. Some modules or routines may be written in assembly language or even micro-code to enhance performance and/or memory usage.

The present invention is described hereinafter with reference to flowchart and/or block diagram illustrations of methods, systems, and computer program products in accordance with exemplary embodiments of the invention. It will be understood that each block of the flowchart and/or block diagram illustrations, and combinations of blocks in the flowchart and/or block diagram illustrations, may be implemented by computer program instructions and/or hardware operations. These computer program instructions may be provided to a processor of a general purpose computer, a special purpose computer, or other programmable data processing apparatus to produce a machine, such that the instructions, which execute via the processor of the computer or other programmable data processing apparatus, create means for implementing the functions specified in the flowchart and/or block diagram block or blocks.

These computer program instructions may also be stored in a computer usable or computer-readable memory that may direct a computer or other programmable data processing apparatus to function in a particular manner, such that the instructions stored in the computer usable or computer-readable memory produce an article of manufacture including instructions that implement the function specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart and/or block diagram block or blocks.

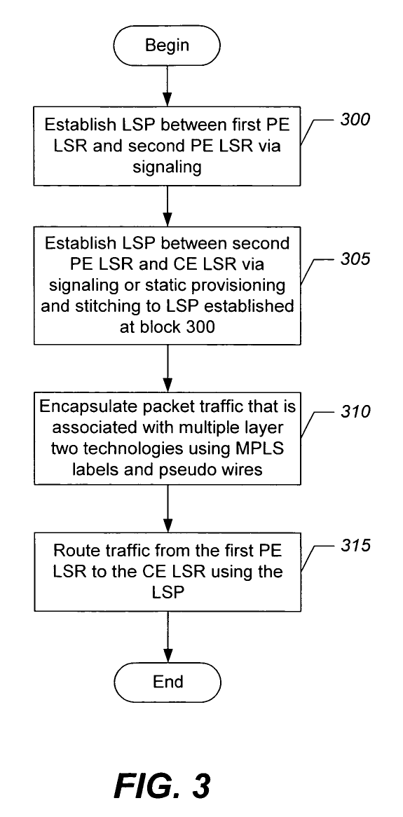

Operations for encapsulating packet traffic that is associated with multiple layer two technologies in accordance with some embodiments of the present invention will now be described with reference to FIGS. 3 and 2. Referring now to FIG. 3, operations begin at block 300 where a LSP is established using conventional procedures (e.g., Label Distribution Protocol (LDP)) between a first PE LSR and a second PE LSR, such as, for example, PE LSR 205 and PE LSR 210 of FIG. 2. At block 305, an LSP is established between the second PE LSR and a CE LSR, such as for example, second PE LSR 210 and CE LSR 245, using static LSP provisioning with stitching to the LSP established at block 300 or LSP signaling. At block 310, traffic that is associated with multiple types of layer two technologies is encapsulated with one or more MPLS labels and/or pseudo wires at, for example, the first PE LSR 205. The encapsulated traffic may then be routed from the first PE LSR to the second PE LSR and onto the CE LSR using the established LSP at block 315. In accordance with some embodiments of the present invention, each packet may comprise a control word that identifies the particular layer two technology that the packet is associated with to facilitate distinguishing between the various types of layer two technologies at the CE LSR 250 of FIG. 2, for example.

Advantageously, the present invention may allow traffic from multiple types of layer two technologies to be aggregated without regard to the layer three protocol used in a way that provides protocol conversion and may meet regulatory constraints, for example, for regulated service providers that wish to provide service across local access and transport area (LATA) boundaries.

The flowchart of FIG. 3 illustrates the architecture, functionality, and operations of some embodiments of methods, systems, and computer program products for encapsulating packet traffic that is associated with multiple layer two technologies. In this regard, each block represents a module, segment, or portion of code, which comprises one or more executable instructions for implementing the specified logical function(s). It should also be noted that in other implementations, the function(s) noted in the blocks may occur out of the order noted in FIG. 3. For example, two blocks shown in succession may, in fact, be executed substantially concurrently or the blocks may sometimes be executed in the reverse order, depending on the functionality involved.

Many variations and modifications can be made to the embodiments described herein without substantially departing from the principles of the present invention. All such variations and modifications are intended to be included herein within the scope of the present invention, as set forth in the following claims.

1. A method of operating a multiprotocol label switching (MPLS) network, comprising:
establishing a label switched path (LSP) that connects a first provider edge (PE) label switched router (LSR) a second PE LSR, and a customer edge (CE) LSR;
encapsulating packet traffic that is associated with a plurality of different layer two technologies with an MPLS label; and
securely routing the encapsulated packet traffic from the first PE LSR through the second PE LSR to the CE LSR using the LSP.

2. The method of claim 1, wherein the layer two technologies comprise asynchronous transfer mode (ATM) technology, frame relay technology, point-to-point protocol/high level data link control (HDLC) technology, private line time division multiplexing (TDM), and/or Ethernet technology.

3. The method of claim 1, wherein the MPLS label is signaled between the first PE LSR and the CE LSR and wherein the second PE LSR uses an internal service provider IP-virtual private network to maintain a securely partitioned network for customers.

4. The method of claim 1, wherein the MPLS label is statically provisioned from the second PE LSR to the CE LSR and stitched to a signaled LSP in a service provider network that connects the first and second PE LSRs.

5. The method of claim 4, further comprising:
provisioning a pseudo wire virtual circuit within the LSP for each one of a plurality of attachment circuits at the first PE LSR.

6. The method of claim 5, wherein the LSP and/or pseudo wires, which are terminated via signaling at the second PE LSR, transit on to the CE LSR.

7. The method of claim 1, wherein each of the packets comprising the packet traffic comprises a control word that identifies one of the plurality of different layer two technologies that the respective packet is associated with.

8. A system for operating a multiprotocol label switching (MPLS) network, comprising:
means for establishing a label switched path (LSP) that connects a first provider edge (PE) label switched router (LSR) a second PE LSR, and a customer edge (CE) LSR;
means for encapsulating packet traffic that is associated with a plurality of different layer two technologies with an MPLS label; and
means for securely routing the encapsulated packet traffic from the first PE LSR through the second PE LSR to the CE LSR using the LSP.

9. The system of claim 8, wherein the layer two technologies comprise asynchronous transfer mode (ATM) technology, frame relay technology, point-to-point protocol/high level data link control (HDLC) technology, private line time division multiplexing (TDM), and/or Ethernet technology.

10. The system of claim 8, wherein the MPLS label is signaled between the first PE LSR and the CE LSR and wherein the second PE LSR uses an internal service provider IP-virtual private network to maintain a securely partitioned network for customers.

11. The system of claim 8, wherein the MPLS label is statically provisioned from the second PE LSR to the CE LSR and stitched to a signaled LSP in a service provider network that connects the first and second PE LSRs.

12. The system of claim 11, further comprising:
means for provisioning a pseudo wire virtual circuit within the LSP for each one of a plurality of attachment circuits at the first PE LSR.

13. The system of claim 12, wherein the LSP and/or pseudo wires, which are terminated via signaling at the second PE LSR, transit on to the CE LSR.

14. The system of claim 8, wherein each of the packets comprising the packet traffic comprises a control word that identifies one of the plurality of different layer two technologies that the respective packet is associated with.

15. A computer program product for operating a multiprotocol label switching (MPLS) network, comprising:
a computer readable storage medium having computer readable program code embodied therein, the computer readable program code comprising:
computer readable program code configured to establish a label switched path (LSP) that connects a first provider edge (PE) label switched router (LSR) a second PE LSR, and a customer edge (CE) LSR;
computer readable program code configured to encapsulate packet traffic that is associated with a plurality of different layer two technologies with an MPLS label; and
computer readable program code configured to securely route the encapsulated packet traffic from the first PE LSR through the second PE LSR to the CE LSR using the LSP.

16. The computer program product of claim 15, wherein the layer two technologies comprise asynchronous transfer mode (ATM) technology, frame relay technology, point-to-point protocol/high level data link control (HDLC) technology, private line time division multiplexing (TDM), and/or Ethernet technology.

17. The computer program product of claim 15, wherein the MPLS label is signaled between the first PE LSR and the CE LSR and wherein the second PE LSR uses an internal service provider IP-virtual private network to maintain a securely partitioned network for customers.

18. The computer program product of claim 15, wherein the MPLS label is statically provisioned from the second PE LSR to the CE LSR and stitched to a signaled LSP in a service provider network that connects the first and second PE LSRs.

19. The computer program product of claim 18, further comprising:
computer readable program code configured to provision a pseudo wire virtual circuit within the LSP for each one of a plurality of attachment circuits at the first PE LSR.

20. The computer program product of claim 19, wherein the LSP and/or pseudo wires, which are terminated via signaling at the second PE LSR, transit on to the CE LSR.

21. The computer program product of claim 15, wherein each of the packets comprising the packet traffic comprises a control word that identifies one of the plurality of different layer two technologies that the respective packet is associated with.
